(19) United States
(12) Patent Application Publication
(10) Pub. No.: US 2009/0095568 A1
(43) Pub. Date: Apr. 16, 2009

(54) LADDER ACCESSORY

(76) Inventors: Bruce Webster, Fort Worth, TX (US); Stephen Gregg, Fort Worth, TX (US)

Correspondence Address: Daniel V. Thompson;Thompson & Gustavson, LLP, 9304 Forest Lane, Suite N253, Dallas, TX, 75243, US

(21) Appl. No.: 11/870,066

(22) Filed: Oct. 10, 2007

(51) Int. Cl. E06C 7/14; E06C 7/16

(52) U.S. Cl. 182/129; 211/70.6; 248/210

(57) ABSTRACT

A ladder accessory has a marrying pocket, a handle adapted to hold a paint vessel, and magnetic tool retainment.

### FIELD OF THE INVENTION

This invention relates generally to ladder accessories, and, more particularly, to tool carrying device adapted to fit on top of a ladder.

### BACKGROUND OF THE INVENTION

Working on a ladder takes stamina. One must repeatedly climb up and down the ladder, one must move the ladder from one location to another, and one usually must also carry tools and parts up and down the ladder. To save unnecessary movement up and down a ladder, it is useful for a person to have tool trays (“totes”) or tool holders which will support one or more of the tools a person might need while working near the upper portion of the ladder. The same can be said with respect to supplies and vessels of paint that the person may want at the top of the ladder.

A number of ladder-top tool and supply “totes” are known in the art, however a drawback of all of them is that they are either loosely-fitted to the top, such that they must be removed when the ladder is tipped horizontal for transport, or else they are firmly lashed to the top with complex fasteners such as straps. We have found that a properly dimensioned “marrying” pocket at the bottom of the tote allows a snug fit that is readily removable yet stays in place for short distance transport of the ladder in the horizontal position.

Other prior art totes have provisions for holding paint vessels or cans, but none makes use of a handle and tray wall structure that is already provided for the usual purposes to also hold paint vessels.

Finally, none of the prior art totes provides a magnetic method of holding tools and supplies in the tote.

### SUMMARY OF THE INVENTION

A ladder accessory has a marrying pocket, a handle adapted to hold a paint vessel, and magnetic tool retainment.

### BRIEF DESCRIPTION OF DRAWINGS

A more complete understanding of the invention and its advantages will be apparent from the Detailed Description taken in conjunction with the accompanying Drawings, in which:

FIG. 1 is a perspective view;

FIG. 2 is a side view with the handle in the deployed position;

FIG. 3 is a top view with the handle in the stowed position;

FIG. 4 is a bottom view;

FIG. 5 is a sectional view taken along lines 5-5 of FIG. 2;

FIG. 6 is a sectional view taken along lines 6-6 of FIG. 3; and

FIG. 7 is a sectional view taken along lines 7-7 of FIG. 6.

### DETAILED DESCRIPTION

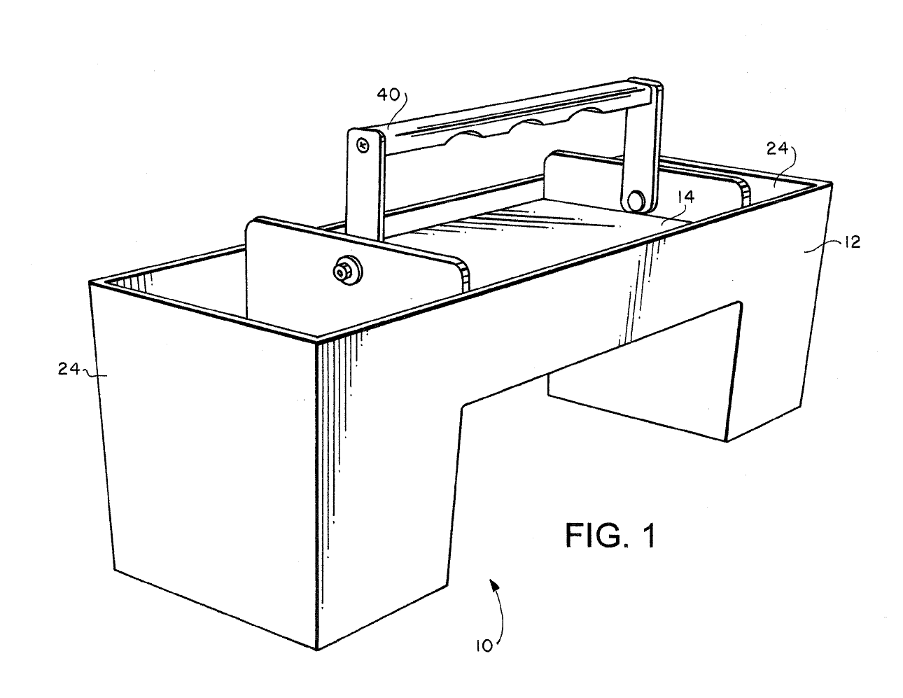

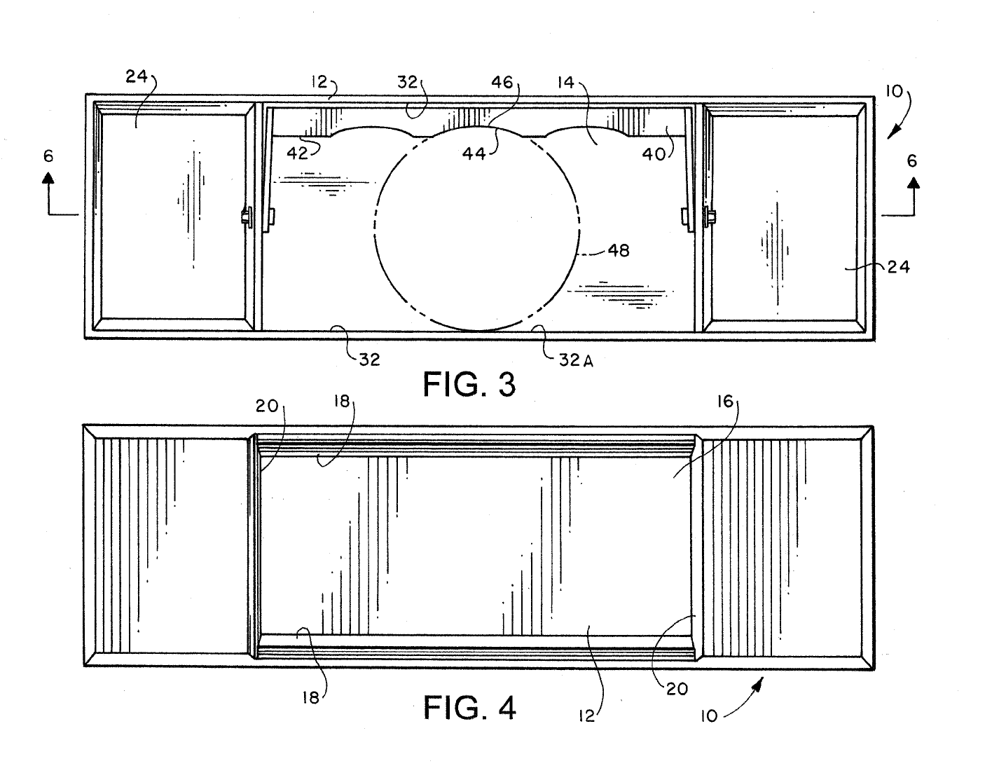

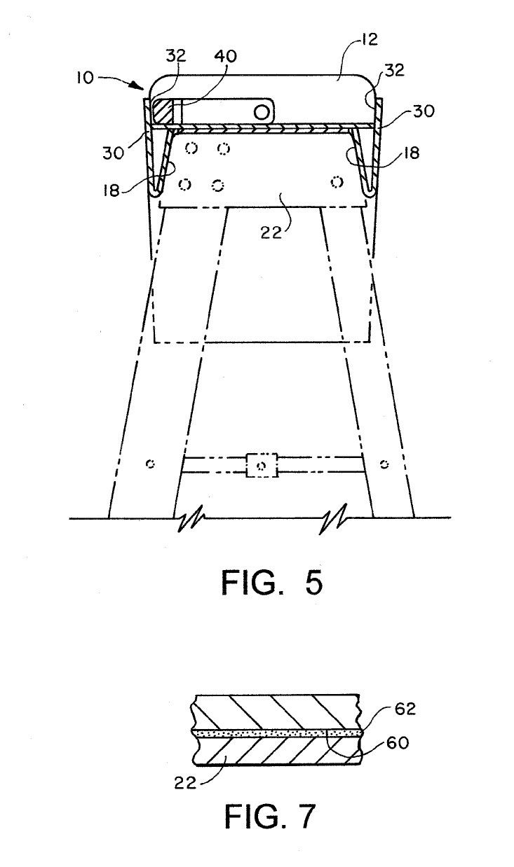

Referring to FIGS. 1-7, where like numerals refer to like and corresponding parts, a ladder accessory 10, has a main body 12 with a central tray 14 and a marrying pocket 16 below the central tray 14. The marrying pocket 16 is formed of two side walls 18 and two end walls 20. The marrying pocket end walls 20 and side walls 18 are tapered and dimensioned to enable a snug fit with a selected ladder top 22, as best shown in FIGS. 5 and 6.

The marrying pocket concept can be used with just a tray; however, it may be desirable to provide two end containers 24 at opposite ends of the central tray 14. In that event, the end containers 24 have inner walls 26 coextensive at top portions thereof with end walls 28 of the central tray (FIG. 6). End container inner walls 26 have lower portions below the top portions, with the lower portions being tapered to form the end walls 20 of the marrying pocket. The marrying pocket side walls 18 extend between the tapered lower portions of the end container inner walls 26. Side transition walls 30 (FIG. 5) extend between the parallel central tray side walls 32 and the marrying pocket side walls 18, with the side transition walls 30, central tray side walls 32 and marrying pocket side walls 18 being a continuous, folded construction, as best shown in FIG. 5.

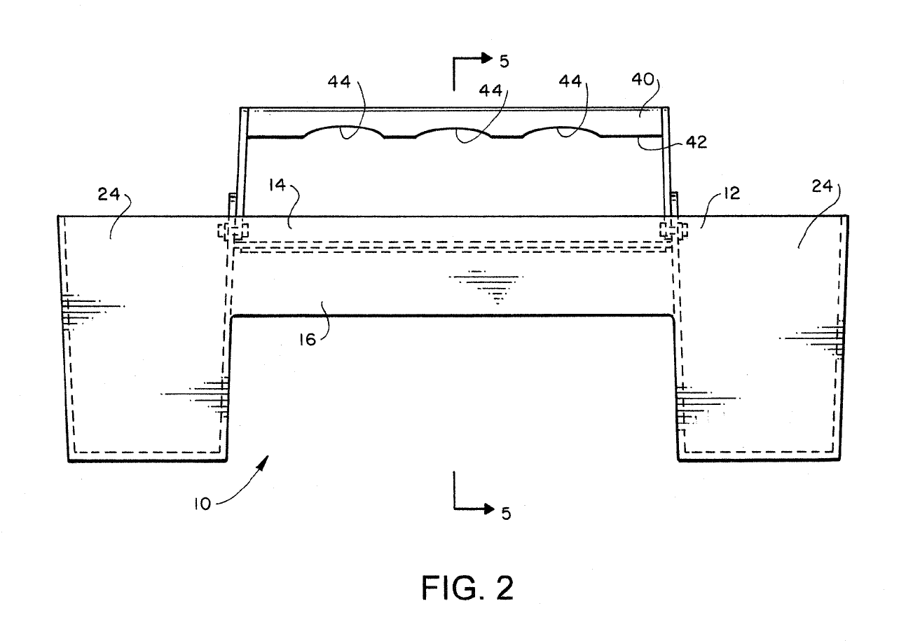

A pivoting handle 40 is connected to the end walls 28 of central tray 14. The handle 40 is pivotable between stowed (FIG. 2) and deployed (FIGS. 3 and 6) positions. The handle 40 includes an inner surface 42 with a plurality of semi-cylindrical walls 44 each dimensioned to closely-fit a portion of a cylindrical paint vessel wall 46 (FIG. 3) when the handle 40 is in the stowed position. The semi- cylindrical walls 44 cooperate with an opposite central tray side wall 32A (in FIG. 3) to hold the paint vessel 48.

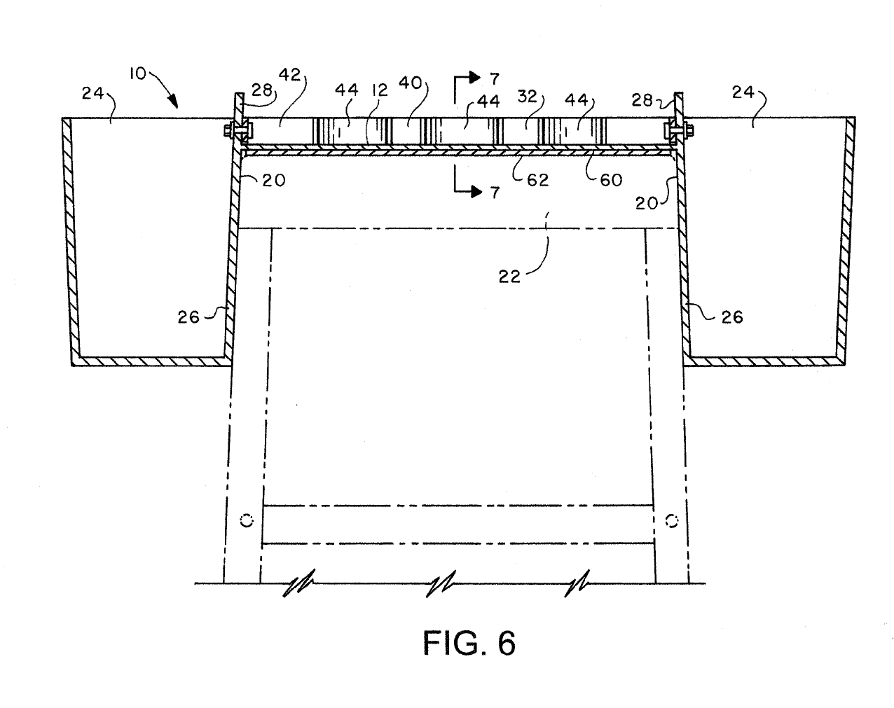

The central tray 14 has a bottom wall 60 and a magnetic sheet 62 adhesively attached to the bottom wall 60 of the central tray 14, as best shown in FIGS. 6 and 7. The magnetic holding power of the sheet 62 and the thickness of the bottom wall 60 is selected to hold tools and supplies sitting in the central tray 14.

In operation, the marrying pocket enables a snug yet readily removable fit of the accessory to a selected ladder top. Where the accessory is formed of slightly flexible plastic, the desired snugness of fit for a selected ladder will be readily obtained. The handle provides structure for using a paint can, but no added parts are needed as the vessel-holding surfaces are formed on the handle that is provided as a matter of course. The magnetic sheet under the central tray provides a minimal tool holding force, so that they may still be picked up but are protected from falling under normal jostling of the ladder.

It will be understood that each of the elements described above, or two or more together, may also find a useful application in other types of constructions differing from the type described above.

While the invention has been illustrated and described as embodied in a particular spatter screen mounting system, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A ladder accessory, comprising:
a main body with a central tray and a marrying pocket below the central tray;
the marrying pocket being formed of two side walls and two end walls; and
the marrying pocket end walls and side walls being tapered and dimensioned to enable a snug fit with a selected ladder top.

2. The ladder accessory of claim 1 with two end containers at opposite ends of the central tray.

3. The ladder accessory of claim 1 with the central tray being formed of two parallel side walls, two end walls and a bottom wall.

4. The ladder accessory of claim 3 with two end containers at opposite ends of the central tray.

5. The ladder accessory of claim 4 with the end containers having inner walls coextensive at top portions thereof with the end walls of the central tray, the end container inner walls having lower portions below the top portions, with the lower portions being tapered to form the end walls of the marrying pocket, and
with the marrying pocket side walls extending between the tapered lower portions of the end container inner walls.

6. The ladder accessory of claim 5 with side transition walls extending between the central tray side walls and the marrying pocket side walls, and with the side transition walls, central tray side walls and marrying pocket side walls being a continuous, folded construction.

7. A ladder accessory, comprising:
a main body adapted to fit on top of a ladder, the main body having a central tray, and the central tray having two parallel side walls and two end walls;
a pivoting handle connected to the end walls of the central tray, with the handle being pivotable between stowed and deployed positions; and
the handle including an inner surface with at least one semi-cylindrical wall dimensioned to closely-fit a portion of a cylindrical paint vessel wall when the handle is in the stowed position, the semi-cylindrical wall cooperating with an opposite central tray side wall to hold the paint vessel.

8. The ladder accessory of claim 7 with the handle inner surface having a plurality of semi-cylindrical walls.

9. The ladder accessory of claim 8 with two end containers at opposite ends of the central tray.

10. The ladder accessory of claim 7 with a marrying pocket below the central tray;
the marrying pocket being formed of two side walls and two end walls; and
the marrying pocket end walls and side walls being tapered and dimensioned to enable a snug fit with a selected ladder top.

11. The ladder accessory of claim 10 with two end containers at opposite ends of the central tray.

12. The ladder accessory of claim 11 with the end containers having inner walls coextensive at top portions thereof with the end walls of the central tray, the end container inner walls having lower portions below the top portions, with the lower portions being tapered to form the end walls of the marrying pocket, and
with the marrying pocket side walls extending between the tapered lower portions of the end container inner walls.

13. A ladder accessory, comprising:
a main body adapted to fit on top of a ladder, the main body having a central tray, and the central tray having a bottom wall; and
a magnetic sheet fitted under the bottom wall of the central tray, with the magnetic holding power of the sheet and the thickness of the bottom wall selected to hold tools and supplies sitting in the central tray.

14. The ladder accessory of claim 13 with the magnetic sheet adhesively attached to the bottom wall of the central tray.

15. The ladder accessory of claim 13 with a marrying pocket below the central tray;
the marrying pocket being formed of two side walls and two end walls; and
the marrying pocket end walls and side walls being tapered and dimensioned to enable a snug fit with a selected ladder top.

16. The ladder accessory of claim 15 with two end containers at opposite ends of the central tray.

17. The ladder accessory of claim 16 with the end containers having inner walls coextensive at top portions thereof with the end walls of the central tray, the end container inner walls having lower portions below the top portions, with the lower portions being tapered to form the end walls of the marrying pocket, and
with the marrying pocket side walls extending between the tapered lower portions of the end container inner walls.

18. The ladder accessory of claim 13 with the central tray having two parallel side walls and two end walls;
a pivoting handle connected to end walls of the central tray, the handle being pivotable between stowed and deployed positions; and
the handle including an inner surface with at least one semi-cylindrical wall dimensioned to closely-fit a portion of a cylindrical paint vessel wall when the handle is in the stowed position, the semi-cylindrical wall cooperating with an opposite central tray side wall to hold the paint vessel.

19. The ladder accessory of claim 18 with the handle inner surface having a plurality of semi-cylindrical walls.

20. A ladder accessory, comprising:
a main body with a central tray and a marrying pocket below the central tray;
the central tray being formed of two parallel side walls, two end walls and a bottom wall;
the marrying pocket being formed of two side walls and two end walls;
the marrying pocket end walls and side walls being tapered and dimensioned to enable a snug fit with a selected ladder top;
with two end containers at opposite ends of the central tray;
with the end containers having inner walls coextensive at top portions thereof with the end walls of the central tray, the end container inner walls having lower portions below the top portions, with the lower portions being tapered to form the end walls of the marrying pocket;
with the marrying pocket side walls extending between the tapered lower portions of the end container inner walls;
with side transition walls extending between the central tray side walls and the marrying pocket side walls, the side transition walls, central tray side walls and marrying pocket side walls being a continuous, folded construction;
a pivoting handle connected to the end walls of central tray, the handle being pivotable between stowed and deployed positions;
the handle including an inner surface with a plurality of semi-cylindrical walls each dimensioned to closely-fit a portion of a cylindrical paint vessel wall when the handle is in the stowed position, the semi-cylindrical walls cooperating with an opposite central tray side wall to hold the paint vessel;
the central tray having a bottom wall; and
a magnetic sheet adhesively attached to the bottom wall of the central tray, with the magnetic holding power of the sheet and the thickness of the bottom wall selected to hold tools and supplies sitting in the central tray.
